(19) United States
(12) Patent Application Publication
(10) Pub. No.: US 2015/0356944 A1
(43) Pub. Date: Dec. 10, 2015

(54) METHOD FOR CONTROLLING SCENE AND ELECTRONIC APPARATUS USING THE SAME

(71) Applicants: Tsung-Hsien Hsieh, New Taipei City (TW); Yi-Chun Lu, New Taipei City (TW); Chih-Hung Huang, New Taipei City (TW); Ya-Cherng Chu, New Taipei City (TW)

(72) Inventors: Tsung-Hsien Hsieh, New Taipei City (TW); Yi-Chun Lu, New Taipei City (TW); Chih-Hung Huang, New Taipei City (TW); Ya-Cherng Chu, New Taipei City (TW)

(73) Assignee: OPTOMA CORPORATION, New Taipei City (TW)

(21) Appl. No.: 14/298,988

(22) Filed: Jun. 9, 2014

(51) Int. Cl. G09G 5/02; G06K 9/46; G06K 9/52; G06T 7/20; G06K 9/62

(52) U.S. Cl. CPC G09G 5/02; G06T 7/20; G06K 9/6201; G06K 9/52; G06K 9/4661; G06K 9/4642

(57) ABSTRACT

A method for controlling a scene and an electronic apparatus using the same are provided. The method includes: retrieving an input image, wherein the input image comprises a plurality of pixels; classifying the pixels into a plurality of categories according to color information of each of the pixels; selecting a plurality of candidate colors according to the color information of each of the pixels; and generating a color set according to the categories and the candidate colors.

### BACKGROUND

1. Field of the Invention

The invention relates to a method for controlling a scene and an electronic apparatus using the same, in particular, to a method for controlling a scene light according to an input image and an electronic apparatus using the same.

2. Description of Related Art

Conventional scene light displayer determines the scene light to be displayed according to several ways. The scene light displayer provides the user with a user interface, such that the user chooses the desired scene light by tapping the corresponding color contained in the image being displayed by the user interface. In other words, the scene light displayer determines the scene light according to user inputs, instead of automatically determining the scene light. Therefore, when the image being displayed is changed, the scene light displayer would not correspondingly change the scene light, such that the scene light does not fit the image being currently displayed. From another point of view, the mechanism mentioned above is not instinctive to the user as well.

Besides, the screen of the scene light displayer is disposed with several fixed color examining elements, and hence the scene light displayer determines the scene light according to the colors captured by the fixed color examining elements in the image being displayed. However, the captured colors only correspond to a small portion of the displayed image, and hence the determined scene light does not properly characterize the overall tone of the displayed image.

The related patents are U.S. Publication No. 20080056619, Taiwan Publication No. 201118780 and Taiwan Patent No. 1308729, though the mechanism of determining the color of the scene light are still not instinctive and not proper.

### SUMMARY

Accordingly, the invention is directed to a method for controlling a scene and an electronic apparatus using the same, which may properly and automatically determine the scene lights.

A method for controlling a scene is introduced herein. The method includes: retrieving an input image, wherein the input image includes a plurality of pixels; classifying the pixels into a plurality of categories according to color information of each of the pixels; selecting a plurality of candidate colors according to the color information of each of the pixels, and generating a color set according to the categories and the candidate colors.

In the embodiment, the step of selecting the candidate colors according to the color information of each of the pixels comprises: selecting the candidate colors from the categories according to the color information of each of the pixels.

In another embodiment, the step of classifying the pixels into the categories according to the color information of each of the pixels comprises: classifying the pixels into the categories from the candidate colors according to the color information of each of the pixels. The step of classifying the pixels into the categories according to the color information of each of the pixels comprises performing a quantization process to the pixels to quantize the pixels into a plurality of specific data, wherein the specific data correspond to the categories. And the step of classifying the pixels into the categories according to the color information of each of the pixels comprises: performing a color quantization process to the pixels to quantize the pixels into a plurality of specific colors according to the color information having a color of each of the pixels, wherein the specific colors correspond to the categories. The step of classifying the pixels into the categories according to the color information of each of the pixels comprises: performing a lightness quantization process to the pixels to quantize the pixels into a plurality of specific lightness according to the color information having a lightness of each of the pixels, wherein the specific lightness correspond to the categories. The step of classifying the pixels into the categories according to the color information of each of the pixels comprises: performing a chroma quantization process to the pixels to quantize the pixels into a plurality of specific chromas according to the color information having a chroma of each of the pixels, wherein the specific chromas correspond to the categories. The step of classifying the pixels into the categories according to the color information of each of the pixels comprises: performing a hue angle quantization process to the pixels to quantize the pixels into a plurality of specific hue angles according to the color information having a hue angle of each of the pixels, wherein the specific hue angles correspond to the categories.

The step of selecting the candidate colors according to the color information of each of the pixels comprises: choosing a plurality of specific pixels; and setting colors of the chosen specific pixels as the candidate colors. The step of selecting the candidate colors according to the color information of each of the pixels comprises: performing a quantization process to the pixels to quantize the pixels into a plurality of specific pixels; generating a plurality of color histograms of the specific pixels; selecting a predetermined number of the specific pixels according to the color histograms; and setting colors of the selected specific pixels as the candidate colors.

In the embodiment, the selected predetermined number is determined by the specific pixels having predetermined color histograms.

In the embodiment, the method further comprises controlling a scene light according to the color set.

In the embodiment, the method further comprises controlling a scene light according to the color set while the input image is displayed, comprising: adjusting the scene light as a first color of the color set; and changing the scene light to a second color of the color set after the input image has been displayed for a predetermined period.

In the embodiment, before the step of controlling the scene light according to the color set while the input image is displayed, further comprises: integrating the color set having a plurality of color subsets, a displaying sequence of the color subsets, and a plurality of displaying durations related to the color subsets as a scene file, wherein the step of controlling the scene light according to the color set while the input image is displayed comprising: accessing the scene file to retrieve a first color within the color subsets of the color set; adjusting the scene light as the first color; and changing the scene light to a second color within the color subsets of the color set according to the displaying sequence after the input image has been displayed for a predetermined period, wherein the predetermined period is a specific displaying duration of the displaying durations corresponding to the first color.

In other embodiment, before the step of controlling the scene light according to the color set while the input image is displayed, further comprises: integrating the color set having a plurality of color subsets, the input image, other input images, and other color sets having a plurality of other color subsets corresponding to the other input images as a scene file, wherein the scene file comprises a displaying sequence of all of the color subsets and a plurality of displaying durations related to all of the color subsets; wherein the step of controlling the scene light according to the color set while the input image is displayed comprises: accessing the scene file to retrieve a first color within the all color subsets of the color set; adjusting the scene light as the first color; and changing the scene light to a second color within the all color subsets of the color set according to the displaying sequence after the input image has been displayed for a predetermined period, wherein the predetermined period is a specific displaying duration of the displaying durations corresponding to the first color.

The method further comprises: retrieving a sound file; and integrating the sound file, the color set, and the input image as a scene file and wherein the step of integrating the sound file, the color set, and the input image as the scene file comprises: dividing a playing duration of the sound file into a plurality of sections; mapping a plurality of color subsets of the color set to at least one part of the sections; integrating the mapped color subsets and the part of the sections with the input image as the scene file. And the step of controlling the scene light according to the color set while the input image is displayed comprises: accessing the scene file while the input image is displayed; when a specific section of the part of the sections is displayed, adjusting the scene light as a specific color within the color subsets of the color set corresponding to the specific section.

An electronic apparatus is introduced herein. The electronic apparatus includes a user interface unit, a memory, and a processing unit. The memory stores information including program routines. The program routines include a retrieving module, a classifying module, a selecting module, and generating module. The retrieving module retrieves an input image, wherein the input image includes a plurality of pixels. The classifying module classifies the pixels into a plurality of categories according to color information of each of the pixels. The selecting module selects a plurality of candidate colors according to the color information of each of the pixels. The generating module generates a color set according to the categories and the candidate colors. The processing unit is coupled to the user interface unit and the memory, and executes the program routines.

In the embodiment, the selecting module selects the candidate colors from the categories according to the color information of each of the pixels.

In the embodiment, the classifying module classifies the pixels into the categories from the candidate colors according to the color information of each of the pixels.

In the embodiment, the classifying module performs a quantization process to the pixels to quantize the pixels into a plurality of specific data, wherein the specific data correspond to the categories.

In the embodiment, the classifying module performs a color quantization process to the pixels to quantize the pixels into a plurality of specific colors according to the color information having a color of each of the pixels, wherein the specific colors correspond to the categories.

In the embodiment, the classifying module performs a lightness quantization process to the pixels to quantize the pixels into a plurality of specific lightness according to the color information having a lightness of each of the pixels, wherein the specific lightness correspond to the categories.

In the embodiment, the classifying module performs a chroma quantization process to the pixels to quantize the pixels into a plurality of specific chromas according to the color information having a chroma of each of the pixels, wherein the specific chromas correspond to the categories.

In the embodiment, the classifying module performs a hue angle quantization process to the pixels to quantize the pixels into a plurality of specific hue angles according to the color information having a hue angle of each of the pixels, wherein the specific hue angles correspond to the categories.

In the embodiment, the selecting module of the electronic apparatus: chooses a plurality of specific pixels; and sets colors of the chosen specific pixels as the candidate colors.

In the embodiment, the selecting module: performs a quantization process to the pixels to quantize the pixels into a plurality of specific pixels; generates a plurality of color histograms of the specific pixels; selects a predetermined number of the specific pixels according to the color histograms; and sets the selected specific pixels as the candidate colors. The selected predetermined number is determined by the specific pixels having predetermined color histograms.

In the embodiment, the generating module further controls a scene light of a light displaying device according to the color set.

In the embodiment, the generating module further controls a scene light of a light displaying device according to the color set while the input image is displayed, and the generating module further: adjusts the scene light as a first color of the color set; and changes the scene light to a second color of the color set after the input image has been displayed for a predetermined period.

In the embodiment, the generating module further integrates the color set having a plurality of color subsets, a displaying sequence of the color subsets, and a plurality of displaying durations related to the color subsets as a scene file, and the generating module further: transmits the scene file to the light displaying device to control the light displaying device to further: access the scene file to retrieve a first color within the color subsets of the color set; adjust the scene light as the first color; and change the scene light to a second color within the color subsets of the color set according to the displaying sequence after the input image has been displayed for a predetermined period, wherein the predetermined period is a specific displaying duration of the displaying durations corresponding to the first color.

In the embodiment, the generating module further integrates the color set having a plurality of color subsets, the input image, other input images, and other color sets having a plurality of other color subsets corresponding to the other input images as a scene file, wherein the scene file comprises a displaying sequence of all of the color subsets and a plurality of displaying durations related to all of the color subsets, and the generating module further: transmits the scene file to the light displaying device to control the light displaying device to further: access the scene file to retrieve a first color within the all color subsets of the color set; adjust the scene light as the first color; and change the scene light to a second color within the all color subsets of the color set according to the displaying sequence after the input image has been displayed for a predetermined period, wherein the predetermined period is a specific displaying duration of the displaying durations corresponding to the first color.

In the embodiment, the generating module further: retrieves a sound file; and integrates the sound file, the color set, and the input image as a scene file.

In the embodiment, the sound file has a playing duration, and the generating module further: divides the playing duration into a plurality of sections; maps a plurality of color subsets of the color set to at least one part of the sections; integrates the mapped color subsets and the part of the sections with the input image as the scene file.

In the embodiment, the generating module further: transmits the scene file to a light displaying device to control the light displaying device to further: access the scene file while the input image is displayed; when a specific section of the part of the sections is displayed by a sound playing device, adjust the scene light as a specific color within the color subsets of the color set corresponding to the specific section.

In the embodiment, the sound playing device is comprised in the electronic apparatus and is coupled to the processing unit. And the light displaying device is comprised in the electronic apparatus and is coupled to the processing unit.

Based on the above description, the embodiments of the invention provide a method for controlling a scene and an electronic apparatus using the same, which may automatically determine the scene lights by fully considering the colors existing in an image, and hence the determined scene lights may properly characterize the overall tone of the image.

Other objectives, features and advantages of the present invention will be further understood from the further technological features disclosed by the embodiments of the present invention wherein there are shown and described preferred embodiments of this invention, simply by way of illustration of modes best suited to carry out the invention.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an electronic apparatus according to an embodiment of the invention.

FIG. 2 is a flow chart illustrating a method for controlling a scene according to an embodiment of the invention.

FIG. 3 is a flow chart illustrating a method for controlling a scene according to another embodiment of the invention.

FIG. 4 is a flow chart illustrating a method for controlling a scene according to an embodiment of the invention.

FIG. 5 is a flow chart illustrating a method for controlling a scene according to an embodiment of the invention.

FIG. 6 is a flow chart illustrating a method for controlling a scene according to an embodiment of the invention.

FIG. 7 to FIG. 9 are functional block diagrams of electronic apparatuses according to three embodiments of the invention.

FIG. 10 is a schematic diagram illustrating a situation that the light displaying devices control the scene light according to an embodiment of the invention.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

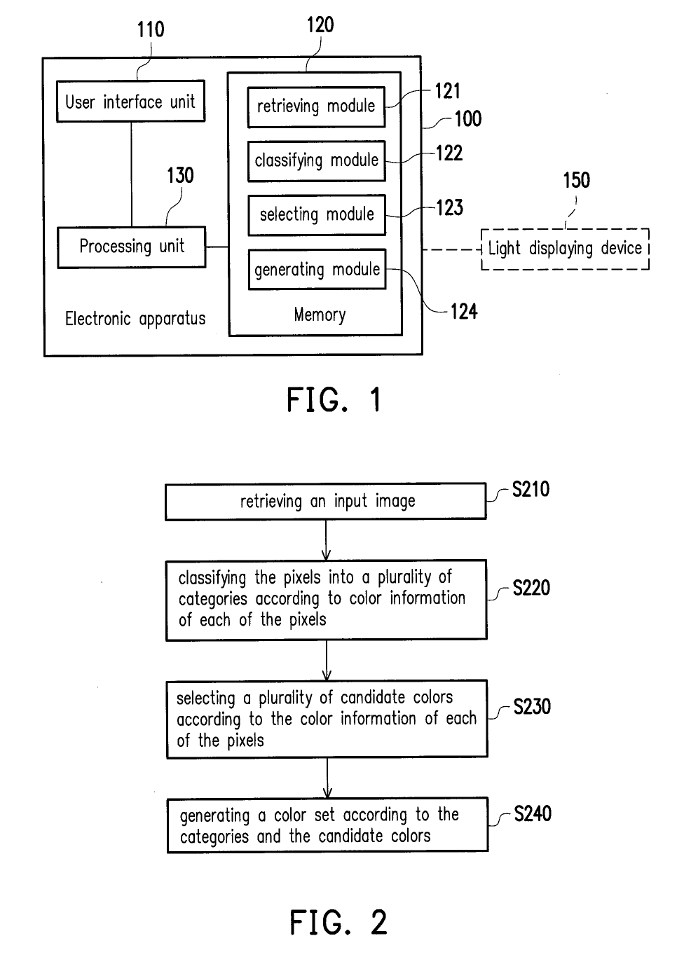

Referring to FIG. 1, in the embodiment, the electronic apparatus 100 includes a user interface unit 110, a memory 120, and a processing unit 130. The electronic apparatus 100 may be, for example, a portable electronic device, such as a smartphone, a personal digital assistant (PDA), a tablet or the like, and the invention is not limited thereto. In some embodiments, the electronic apparatus 100 may be, for example, an illumination system, an audio system, a speaker, an image system, a computer system, a mobile phone, a multimedia player, etc., which is used for outputting sounds and/or color beams, though the invention is not limited thereto.

In the embodiment, the user interface unit 110 is, for example, a touch pad or a touch panel used to receive data and/or a display used to present the data; in the other embodiment, the user interface unit 110 may be a touch screen incorporating the touch panel with the screen, but the invention is not limited thereto. The memory 120 is used to store information such as program routines. The memory 120 is, for example, one or a combination of a stationary or mobile random access memory (RAM), read-only memory (ROM), flash memory, hard disk, or any other similar device, and the memory 120 records a plurality of modules executed by the processing unit 130. To be more specific, the modules mentioned above may be loaded into the processing unit 130 to perform a method for controlling a scene. The scene means that variations of the environment lighting or sound. In the embodiment, the program routines stored within the memory 120 include a retrieving module 121, a classifying module 122, a selecting module 123, and a generating module 124, etc.

The processing unit 130 is coupled to the user interface unit 110 and the memory 120 for controlling the execution of the program routines. In the embodiment, the processing unit 130 may be one or a combination of a central processing unit (CPU), a programmable general-purpose microprocessor, specific-purpose microprocessor, a digital signal processor (DSP), analog signal processor, a programmable controller, application specific integrated circuits (ASIC), a programmable logic device (PLD), an image processor, graphics processing unit (GPU), or any other similar device. In the other embodiment, the processing unit 130 may be processing software, such as signal processing software, digital signal processing software (DSP software), analog signal processing software, image processing software, graphics processing software, audio processing software.

Referring to FIG. 2, in the following description, the method for controlling a scene is described in detail with reference to various components of the electronic apparatus 100.

Referring to FIG. 1 and FIG. 2, in step S210, the processing unit 130 loads and executes the retrieving module 121 of the program routine for retrieving an input image. The input image may be an image going to be displayed on the user interface unit 110 or some other display devices, or an image stored in some storage mediums, but the invention is not limited herein. The input image may include a plurality of pixels, and each of the pixels may be configured with corresponding color information. The color information may include one or a combination of a color, lightness, brightness, a chroma, a saturation, a hue, a hue angle, a color level, a gray level and/or the like, but the invention is not limited thereto.

Referring to FIG. 2, in step S220, the classifying module 122 may classify the pixels into a plurality of categories according to the color information of each of the pixels. To be more specific, a quantization process is performed by the classifying module 122 for quantizing the pixels into a plurality of specific data in the embodiment, where the specific data respectively corresponds to the categories. Besides, the forms of the specific data may be designed by the designers/programmer of the program routines, which are not limited herein. In step S230, the selecting module 123 may select a plurality of candidate colors according to the color information of each of the pixels. In some embodiments, the selecting module 123 may select the candidate colors from the categories mentioned above. The way of selecting the candidate colors may vary in response to the considered color information. Several embodiments would be described herein.

### First Embodiment

In a first embodiment, the color information may be colors of the pixels. Specifically, the quantization process may be a color quantization process, and hence the classifying module 122 may quantize the pixels into a plurality of specific colors. The number of the specific colors may be, for example, 128, 256 or other numbers decided/designed by the user/designer/programmer (e.g., in one embodiment, the designer/programmer may decide/design the default number, such as 256; in some embodiments, the designer/programmer may decide/design at least one default number, and the user may make a decision from the default number(s) through the user interface unit 110), which is not limited thereto. Similarly, the specific colors may respectively correspond to the categories. That is, if the pixels are quantized into K (which is a positive integer) specific colors, there would be K (e.g., 256) categories.

Subsequently, the selecting module 123 may choose specific pixels from the all categories (e.g., 256 categories) and set colors of the chosen specific pixels as the candidate colors. In the embodiment, the selecting module 123 may generate a plurality of color histograms of the specific colors corresponding to the specific pixels. In the embodiment, the height of a color histogram may positively correlate with the number of the corresponding specific color, but the invention is not limited thereto. Afterwards, the selecting module 123 may select a predetermined number of the specific colors (e.g., 256 categories of the specific colors) according to the color histograms. In one embodiment, the selected predetermined number of specific colors is determined by the specific colors having higher color histograms (as predetermined color histograms). For example, if the predetermined number is P (which is a positive integer), the selecting module 123 may select P (e.g., 8) specific colors with highest color histograms (i.e., top 8 colorful color), but the invention is not limited thereto. After selecting the predetermined number of the specific colors with highest color histograms, the selecting module 123 may set the colors corresponding to the selected specific colors as the candidate colors.

### Second Embodiment

When the color information is the lightness of each of the pixels, different categories may correspond to different lightness ranges. Specifically, in the embodiment, the quantization process may be a lightness quantization process, and hence the classifying module 122 may quantize the pixels into a plurality of specific lightness. For example, when the classifying module 122 classifies the pixels, the classifying module 122 may find the overall lightness range of all of the pixels in the input image and divide the overall lightness range by every M (which is a positive number) percent. If M is 10, pixels may be divided into 10 categories of the specific lightness through ranging by every 10%, but the invention is not limited thereto. Next, the selecting module 123 may select a predetermined number (e.g., a positive integer) of the specific pixels from the all categories and set colors of the chosen specific pixels as the candidate colors. For example, if the predetermined number is 10, the selecting module 123 may choose a specific pixel from each of the 10 categories and set colors of the 10 chosen specific pixels as the candidate colors, where the chosen specific pixels may be generated by using histograms, but the invention is not limited thereto.

### Third Embodiment

When the color information is the chroma of each of the pixels, different categories may correspond to different chroma ranges. Specifically, in the embodiment, the quantization process may be a chroma quantization process, and hence the classifying module 122 may quantize the pixels into a plurality of specific chromas. For example, when the classifying module 122 classifies the pixels, the classifying module 122 may find the overall chroma range of all of the pixels in the input image and divide the overall chroma range by every M percent. If M is 10, pixels may be divided into 10 categories of the specific chromas through ranging by every 10%, but the invention is not limited thereto. Next, the selecting module 123 may select a predetermined number (e.g., a positive integral) of the specific pixels from the all categories and set colors of the chosen specific pixels as the candidate colors. For example, if the predetermined number is 20, the selecting module 123 may choose 2 specific pixels from each of the 10 categories and set colors of the 20 chosen specific pixels as the candidate colors, where the chosen specific pixels may be generated by using histograms, but the invention is not limited thereto.

### Fourth Embodiment

When the color information is the hue angle of each of the pixels, different categories may correspond to different hue angle ranges. Specifically, in the embodiment, the quantization process may be a hue angle quantization process, and hence the classifying module 122 may quantize the pixels into a plurality of specific hue angles. For example, when the classifying module 122 classifies the pixels, the classifying module 122 may divide the overall hue angle range (e.g., 360 degrees) by every M degrees. If M is 45, pixels may be divided into 8 categories of the specific hue angles through ranging by every 45 degrees, but the invention is not limited thereto. Next, the selecting module 123 may select a predetermined number (e.g., a positive number) of the specific pixels from the all categories and set colors of the chosen specific pixels as the candidate colors. For example, if the predetermined number is 8, the selecting module 123 may choose a specific pixel from each of the 8 categories and set colors of the 8 chosen specific pixels as the candidate colors, where the chosen specific pixels may be generated by using histograms, but the invention is not limited thereto.

From another point of view, the candidate colors selected in the first, second, third, and fourth embodiments are determined based on quantizedly analyzing the color information of each of the pixels. Thus, the candidate colors may characterize the overall tone of the input image more properly.

In step S240, the generating module 124 may generate a color set according to the categories and the candidate colors. In the embodiment, the generating module 124 may generate the color set like a color list containing the candidate colors.

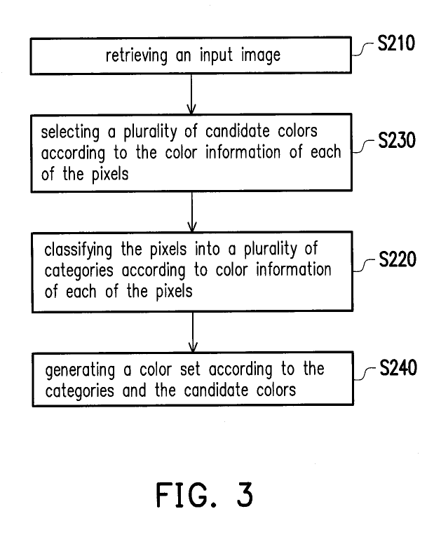

It should be noted that step S230 may also be executed before step S220 in some embodiments, shown in FIG. 3. To be more specific, the selecting module 123 may select the candidate colors according to the color information of each pixel, and then the classifying module 122 may classify the pixels into categories from the candidate colors according to the color information of each pixel. For example, the selecting module 123 may select the candidate colors from the input image having the pixels with color information, and then the classifying operation may be executed by the classifying module 122 based on the selecting result (i.e., the candidate colors selected according to the color information of pixels) from the selecting module 123 for producing the plurality of the categories. Accordingly, the generating module 124 may generate the color set like a color list containing the categories. In the other embodiment, the selecting module 123 may select the candidate colors from a predetermined list of colors and then the classifying module 122 executes the classifying operation, wherein the predetermined list of colors may be chosen/designed according to the requirements of the user/designer/programmer (e.g., the designer/programmer may design the predetermined list of colors provided to be chosen by the user through the user interface unit 110), but the invention is not limited thereto.

Further, in other embodiments, step S220 and S230 may be iteratively and repeatedly performed to obtain the color set according to the categories and candidate colors as well. Accordingly, controlling a scene may be carried out through the descriptions mentioned above.

In the embodiment, the color set generated by the generating module 124 may have a plurality of color subsets (i.e., first color, second color, and etc.) to control the scene light, and the scene light is related to the input image. To be more specific, the generating module 124 may further control the scene light of a light displaying device 150 according to the color set generated based on the categories and the candidate colors. For example, the generating module 124 may control the scene light of the light displaying device 150 as one color (e.g., brown, also the color related to the input image at that time) of the color set, and then the generating module 124 may control the scene light of the light displaying device 150 as another color (e.g., yellow, also the color related to the input image at that time) of the color set. The light displaying device 150 may be a device capable of emitting light, changing a color or imaging, such as an illumination light device (for example, a lamp), an imaging device (for example, a projector, a self-luminous display, a non-self-luminous display, a transmissive display panel, a reflective display panel, a semi-transflective display panel, a digital camera, a video camera, etc.), a computer (a desktop computer, a notebook computer, a tablet PC), a mobile phone, an image displayer, a multimedia player, though the invention is not limited thereto.

In the other embodiment, the generating module 124 may further control the scene light of the light displaying device 150 according to the color set while the input image is displayed. To be more specific, when the input image is displayed, the generating module 124 may further adjust the scene light of the light displaying device 150 as a first color (e.g., red) of the color set. Next, the generating module 124 may change the scene light to a second color (e.g., blue) of the color set after the input image has been displayed for a predetermined period. The predetermined period may be, for example, 10 seconds or other regular/random durations determined by any requests (the designer of the electronic apparatus 100 or user's behavior, for example), which is not limited thereto.

Since the color set generated according to the candidate colors and the categories are automatically determined, the user may not need to manually choose the scene light. That is, the method proposed in the invention may control the scene light in a more instinctive, and the scene light may characterize the overall tone of the input image more properly.

In other embodiments, the electronic apparatus of the invention may generate a scene file, and accordingly use the scene file to control the light displaying device, wherein the scene file includes the information related to controlling the scene light. Details would be provided in the following descriptions.

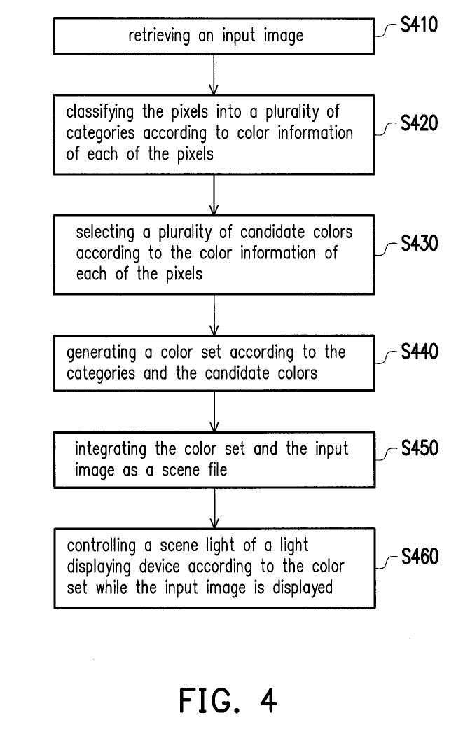

Referring to FIG. 4, in the following descriptions, the method for controlling a scene is described in detail. In step S410, the retrieving module 121 may retrieve an input image. In step S420, the classifying module 122 may classify the pixels into a plurality of categories according to the color information of each of the pixels. In step S430, the selecting module 123 may select a plurality of candidate colors according to the color information of each of the pixels. In step S440, the generating module 124 may generate a color set according to the categories and the candidate colors. The details of steps S410-S440 may be referred to steps S210-S240, which would not be repeated herein.

In some embodiment, the generating module 124 may further integrate the color set having a plurality of color subsets, a displaying sequence of the color subsets of the color set, and a plurality of displaying durations related to the color subsets as a scene file, wherein the scene file may include the displaying sequence of the candidate colors and the displaying durations related to the candidate colors. In detail, the generating module 124 may further arrange the order of the candidate colors and accordingly record the arranged order as the displaying sequence of the candidate colors. Besides, the displaying duration may be the duration of the candidate color being displayed as a scene light.

It should be noted that step S430 may also be executed before step S420 in other embodiments. To be more specific, the generating module 124 may further integrate the color set, a displaying sequence of the color subsets of the color set, and a plurality of displaying durations related to the color subsets as a scene file, wherein the scene file may include the displaying sequence of the categories and the displaying durations related to the categories. In detail, the generating module 124 may further arrange the order of the categories and accordingly record the arranged order as the displaying sequence of the categories. Besides, the displaying duration may be the duration of the categories being displayed as a scene light.

However, a scene file may further have the input image, as shown in FIG. 4. In step S450, the generating module 124 may further integrate the color set and the input image as a scene file. In the embodiment, the scene file may include a displaying sequence of the candidate colors and a plurality of displaying durations related to the candidate colors. In detail, in the embodiment, the generating module 124 may further randomly arrange the order of the candidate colors or arrange the order according to some principles, such as ascending (or descending) lightness/hue angle/chroma/histogram, but the invention is not limited thereto. Afterwards, the generating module 124 may accordingly record the arranged order as the displaying sequence of the candidate colors. Besides, in the embodiment, a displaying duration is the duration of the candidate color being displayed as a scene light, and the displaying duration may be randomly determined or be determined according to other principles designed/chosen by the designer/programmer/user (e.g., the designer/programmer may design a plurality of types for the displaying duration, and the user may choose from all the types), but the invention is not limited thereto. In the embodiment, the generating module 124 may map the displaying durations to the candidate colors in the displaying sequence. Specifically, the generating module 124 may establish a one-to-one mapping relationship between the displaying durations and the candidate colors in the displaying sequence. It should be noted that the displaying sequence of the candidate colors and the displaying durations related to the candidate colors is an example, and the invention is not limited thereto. In the other embodiment, a displaying sequence of the categories and a plurality of displaying durations related to the categories may also be implemented in the step S450.

In step S460, the generating module 124 may control a scene light of a light displaying device 150 according to the color set while the input image is displayed. Specifically, with the scene file, the generating module 124 may transmit the scene file to the light displaying device 150 to control the light displaying device 150 to access the scene file to retrieve a first color within the color subsets of the color set. In the embodiment, the first color may be a first candidate color of the candidate colors. In the other embodiment, the first color may be the color of a first category within the categories. Next, the light displaying device 150 may be controlled to adjust the scene light as the first color. Afterwards, the light displaying device 150 may be controlled to change the scene light to a second color within the color subsets of the color set. In the embodiment, the second color may be a second candidate color of the candidate colors according to the displaying sequence after the input image has been displayed for a predetermined period, wherein the predetermined period is a specific displaying duration of the displaying durations corresponding to the first candidate color. In the other embodiment, the second color may be the color of a second category within the categories, wherein the predetermined period is a specific displaying duration of the displaying durations corresponding to the color of the first category.

Moreover, the light displaying device 150 may be controlled to change the scene light to a third color within the color subsets of the color set according to the displaying sequence after the input image has been displayed for another predetermined period. For example, the light displaying device 150 may be controlled to change the scene light to a third candidate color of the candidate colors according to the displaying sequence after the input image has been displayed for another predetermined period, wherein the other predetermined period is another specific displaying duration of the displaying durations corresponding to the second candidate color. The generating module 124 may control the scene light according to similar rules, which would not be provided herein.

In order to clarify the implements, in the following example, it is assumed that the first, second, and third color within the color subsets of the color set of the input image are the first, second, and third candidate colors. The light displaying device 150 controlled by the generating module 124 is described in detail. For example, assuming the first, second, and third candidate colors of the input image are blue, red, and green; the displaying sequence of the first, second, and third candidate colors are red, blue, and green; the displaying durations of red, blue, and green are 3, 1, and 2 seconds, respectively. Under the assumption, when the input image is displayed, the generating module 124 may control the light displaying device 150 to sequentially display a red scene light for 3 seconds, a blue scene light for 1 second, and a green scene light for 2 seconds.

From another point of view, since the information of the scene light related to the input image has been arranged as a scene file, the electronic apparatus 100 may transmit the scene file to many light displaying devices, such that the each of the light displaying devices may adjust the scene light in the same way while the input image is displayed.

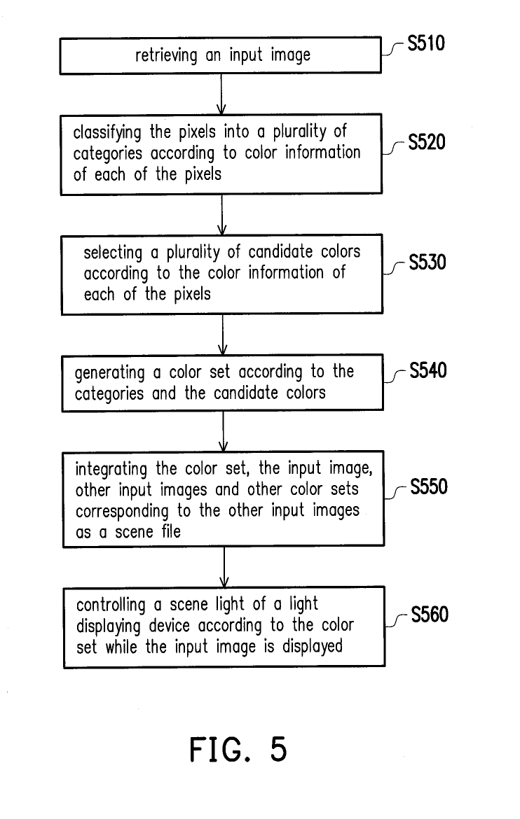

In the other embodiment, a scene file may further have other color sets and other input image(s), as shown in FIG. 5. In step S510, the retrieving module 121 may retrieve an input image. In step S520, the classifying module 122 may classify the pixels into a plurality of categories according to the color information of each of the pixels. In step S530, the selecting module 123 may select a plurality of candidate colors according to the color information of each of the pixels. In step S540, the generating module 124 may generate a color set according to the categories and the candidate colors. The details of steps S510-S540 may be referred to steps S210-S240, which would not be repeated herein. Besides, it should be noted that step S530 may also be executed before step S520 in other embodiments.

In step S550, the generating module 124 may integrate the color set, the input image, other input images, and other color set(s) corresponding to the other input images as a scene file.

The difference between step S450 of the FIG. 4 and step S550 is that step S550 further takes other input images into consideration, while step S450 only considers one input image. Specifically, the electronic apparatus 100 may perform steps S510-S540 to a plurality of input images, and thus may generate a plurality of color sets corresponding to these input images. Afterwards, the generating module 124 may integrate all of the considered input images and their color sets as a scene file. In detail, the generating module 124 may perform step S450 to each of the considered input images, and further arranges an image displaying order to the considered input images. As a result, when the input images are displayed according to the scene file, the input images may be sequentially displayed according to the image displaying order.

In step S560, the generating module 124 may control a scene light of a light displaying device 150 according to the color set while the input image is displayed. Details of step S560 may be referred to step S460, which would not be repeated herein.

In other words, there is an image displaying order about the order of displaying the input images. Meanwhile, to each of the input images, the scene file also stores a displaying sequence of the color subsets of the color set (e.g., candidate colors or the color of the categories) and displaying durations related to the color subsets of the color set (e.g., candidate colors or the color of the categories). That is, the displaying sequence included in the scene file may be the sequence of the candidate colors and the displaying durations may be related to the candidate colors in the embodiment, and the displaying sequence included in the scene file may be the sequence of the categories and the displaying durations may be related to the categories in the other embodiment.

From another point of view, since the information of the scene light related to the plurality of input images have been arranged as a scene file, the electronic apparatus 100 may transmit the scene file to many light displaying devices, such that the each of the light displaying devices may adjust the scene light in the same way while the considered input images are displayed.

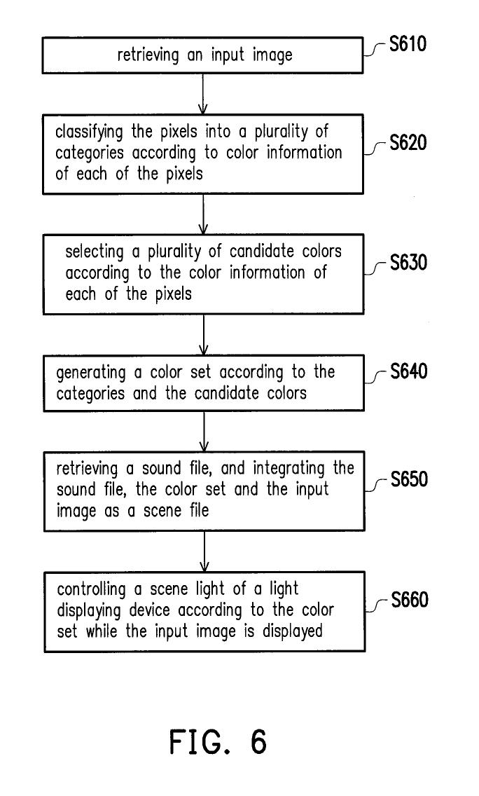

In other embodiments, the scene file may further include the sound played along with the input images, such that the scene light may control with the sound, as shown in FIG. 6. In step S610, the retrieving module 121 may retrieve an input image. In step S620, the classifying module 122 may classify the pixels into a plurality of categories according to the color information of each of the pixels. In step S630, the selecting module 123 may select a plurality of candidate colors according to the color information of each of the pixels. In step S640, the generating module 124 may generate a color set according to the categories and the candidate colors. The details of steps S610-S640 may be referred to steps S210-S240, which would not be repeated herein. Besides, it should be noted that step S630 may also be executed before step S620 in other embodiments.

In step S650, the generating module 124 may retrieve a sound file, and integrate the sound file, the color set, and the input image as a scene file. The sound file may include songs, music, melodies or any kind of sounds, which is not limited thereto.

In one embodiment, the sound file may have a playing duration, and the generating module 124 may divide the playing duration into a plurality of sections. The generating module 124 may uniformly or randomly divide the playing duration, or the generating module 124 may divide the playing duration according to some principles designed by the designer, which is not limited thereto. Next, the generating module 124 may map the color subsets (e.g., candidate colors or the color of the categories) of the color set to at least a part of the sections, and integrate the mapped color subset and the part of the sections with the input image as the scene file.

In step S660, the generating module 124 may control a scene light of a light displaying device according to the color set while the input image is displayed. Specifically, the generating module 124 may transmit the scene file to the light displaying device 150 to control the light displaying device 150 to access the scene file while the input image is displayed. When a specific section of the part of the sections is displayed by a sound playing device, the light displaying device 150 may be controlled to adjust the scene light as a specific color within the color subsets (e.g., candidate color or the color of the categories) of the color set corresponding to the specific section.

As a result, when the input image is displayed along with the sound file, the scene light may be controlled in response to the played sections.

In some embodiments, the light displaying device 150 and the aforementioned sound playing device may be optionally incorporated into the electronic apparatus according to the requirements of the designer.

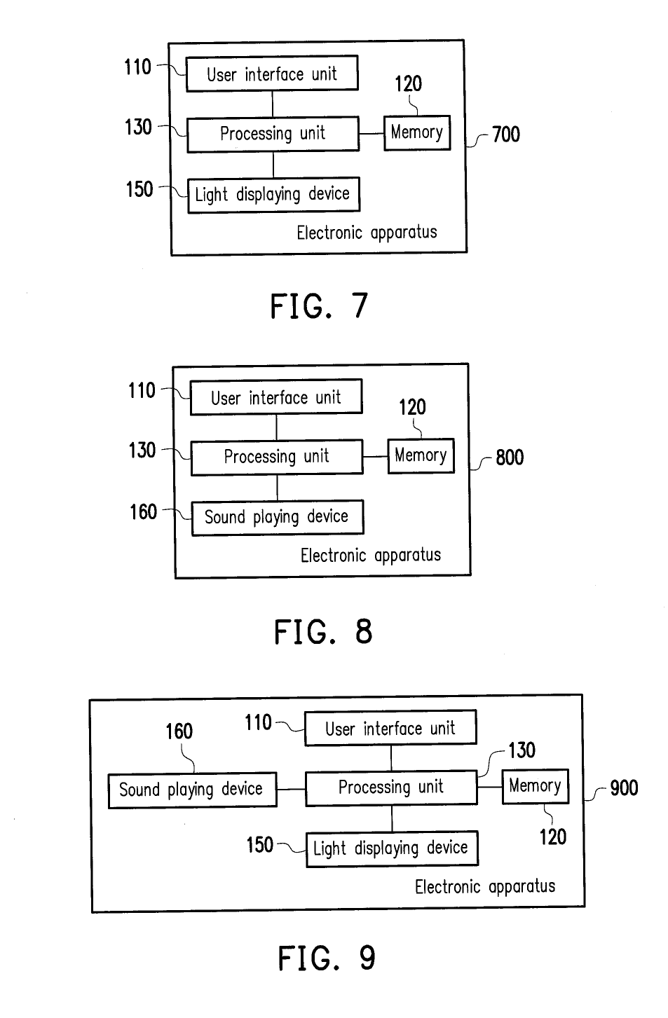

Referring to FIG. 7, in the embodiment, other than including all of the elements of the electronic apparatus 100, the electronic apparatus 700 further incorporates the light displaying device 150.

Referring to FIG. 8, in the embodiment, other than including all of the elements of the electronic apparatus 100, the electronic apparatus 800 further incorporates the sound playing device 160 and connects with the light displaying device 150 (not shown). The sound playing device 160 is, for example, a device capable of producing sounds such as an audio device, a speaker, a multimedia player, an MP3 player, an electronic musical instrument, a projector, a computer, a mobile phone, etc.

Referring to FIG. 9, in the embodiment, other than including all of the elements of the electronic apparatus 100, the electronic apparatus 900 further incorporates the light displaying device 150 and the sound playing device 160.

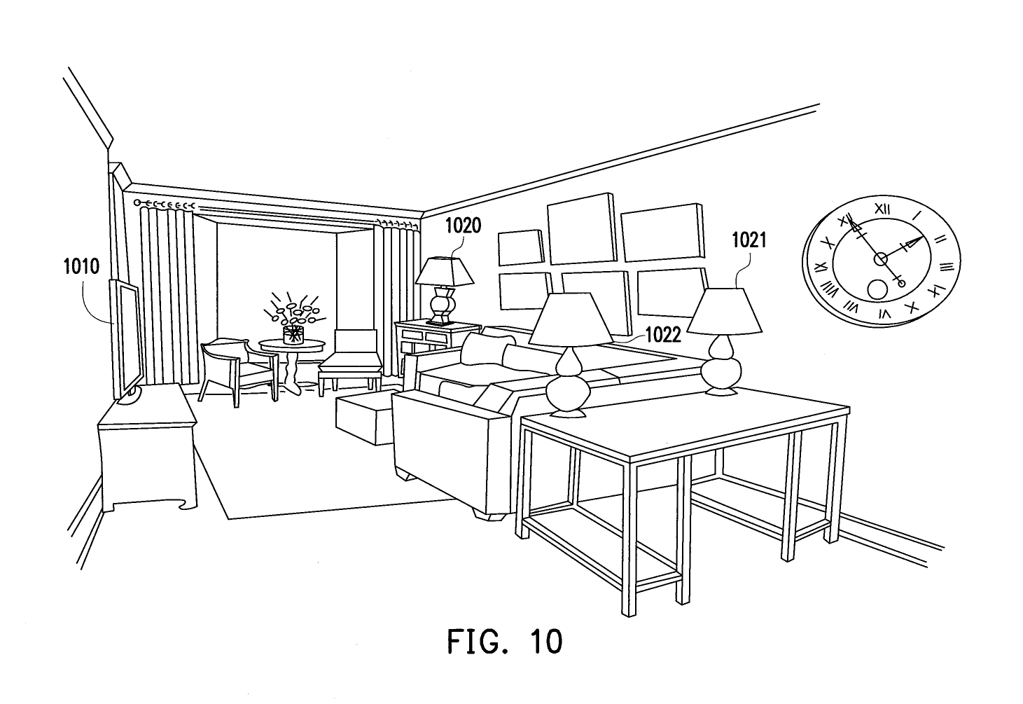

Referring to FIG. 10, in the embodiment, assuming the television 1010 is displaying the input image, and the electronic apparatus (not shown) has transmitted the scene file corresponding to the input image to light displaying devices 1020-1022 in advanced, the light displaying devices 1020-1022 may simultaneously and consistently change the scene light while the television 1010 is displaying the input image. As a result, the scene lights automatically change without the user manual while viewing the input image displayed by the television 1010, such that the user may feel more vicarious or more connected to the atmosphere provided by the displayed input image.

It should be noted that the configuration illustrated in FIG. 10 is just an example, which should not be construed to limit the possible ways of implementations of the invention.

In other embodiments, the scene file may be regarded as a file for indicating a characteristic of at least one of the scene light and situational sound included in the sound file. The scene file may be transmitted through, for example, a thumb drive, a removable hard disk, a memory card, a digital camera, a video camera, an MP3 player, a mobile phone. In some embodiments, the scene file may be transmitted through a network storage space, a network streaming (for example, audio streaming and/or video streaming service, for example, a network service such as Pandora, Youtube, etc.), or provided through data transmission such as email, instant messaging, a community website, an Internet calendar service (ICS), etc. In this way, the electronic apparatus may control the light displaying device and/or the sound playing device to display the scene light and/or play the situational sound included in the sound file, such that the created, edited, recorded and stored situational sound and light effects may be shared and exchanged by different users.

In some embodiments, the scene file may be an audio video interleave (AVI) format file, a moving picture experts group (MPEG) format file, a 3GP format file, an MPG format file, a windows media video (WMV) format file, a flash video (FLV) format file, a shockwave flash (SWF) format file, a real video format file, a windows media audio (WMA) format file, a waveform audio format (WAV) file, an adaptive multi-rate compression (AMR) format file, an advanced audio coding (AAC) format file, an OGG format file, a multimedia container format (MCF) file, a QuickTime format file, a joint photographic experts group (JPEG) format file, a bitmap (BMP) format file, a portable network graphics (PNG) format file, a tagged image file formation (TIFF) format file, an icon format file, a graphics interchange format (GIF) file, a Truevision tagged graphics (TARGA) format file, though the invention is not limited thereto.

To sum up, the embodiments of the invention provide a method for controlling a scene and an electronic apparatus using the same, which may automatically determine the scene lights by fully considering the colors existing in an image, and hence the determined scene lights may properly characterize the overall tone of the image. Besides, in the embodiment of the invention, since the color set are automatically determined, the user does not need to manually choose the scene light while the input image is displayed. That is, the method and the electronic apparatus proposed in the invention may control the scene light in a more instinctive, and the scene light may characterize the overall tone of the input image more properly.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for controlling a scene, comprising:
retrieving an input image, wherein the input image comprises a plurality of pixels;
classifying the pixels into a plurality of categories according to color information of each of the pixels;
selecting a plurality of candidate colors according to the color information of each of the pixels; and
generating a color set according to the categories and the candidate colors.

2. The method as claimed in claim 1, wherein the step of selecting the candidate colors according to the color information of each of the pixels comprising:
selecting the candidate colors from the categories according to the color information of each of the pixels.

3. The method as claimed in claim 1, wherein the step of classifying the pixels into the categories according to the color information of each of the pixels comprising:
classifying the pixels into the categories from the candidate colors according to the color information of each of the pixels.

4. The method as claimed in claim 1, wherein the step of classifying the pixels into the categories according to the color information of each of the pixels comprising:
performing a quantization process to the pixels to quantize the pixels into a plurality of specific data, wherein the specific data correspond to the categories.

5. The method as claimed in claim 1, wherein the step of classifying the pixels into the categories according to the color information of each of the pixels comprising:
performing a color quantization process to the pixels to quantize the pixels into a plurality of specific colors according to the color information having a color of each of the pixels, wherein the specific colors correspond to the categories.

6. The method as claimed in claim 1, wherein the step of classifying the pixels into the categories according to the color information of each of the pixels comprising:
performing a lightness quantization process to the pixels to quantize the pixels into a plurality of specific lightness according to the color information having a lightness of each of the pixels, wherein the specific lightness correspond to the categories.

7. The method as claimed in claim 1, wherein the step of classifying the pixels into the categories according to the color information of each of the pixels comprising:
performing a chroma quantization process to the pixels to quantize the pixels into a plurality of specific chromas according to the color information having a chroma of each of the pixels, wherein the specific chromas correspond to the categories.

8. The method as claimed in claim 1, wherein the step of classifying the pixels into the categories according to the color information of each of the pixels comprising:
performing a hue angle quantization process to the pixels to quantize the pixels into a plurality of specific hue angles according to the color information having a hue angle of each of the pixels, wherein the specific hue angles correspond to the categories.

9. The method as claimed in claim 1, wherein the step of selecting the candidate colors according to the color information of each of the pixels comprising:
choosing a plurality of specific pixels; and
setting colors of the chosen specific pixels as the candidate colors.

10. The method as claimed in claim 1, wherein the step of selecting the candidate colors according to the color information of each of the pixels comprising:
performing a quantization process to the pixels to quantize the pixels into a plurality of specific pixels;
generating a plurality of color histograms of the specific pixels;
selecting a predetermined number of the specific pixels according to the color histograms; and
setting colors of the selected specific pixels as the candidate colors.

11. The method as claimed in claim 10, wherein the selected predetermined number is determined by the specific pixels having predetermined color histograms.

12. The method as claimed in claim 1, further comprising:
controlling a scene light according to the color set.

13. The method as claimed in claim 1, further comprising:
controlling a scene light according to the color set while the input image is displayed, comprising:
adjusting the scene light as a first color of the color set; and
changing the scene light to a second color of the color set after the input image has been displayed for a predetermined period.

14. The method as claimed in claim 13, wherein before the step of controlling the scene light according to the color set while the input image is displayed, further comprising:
integrating the color set having a plurality of color subsets, a displaying sequence of the color subsets, and a plurality of displaying durations related to the color subsets as a scene file,
wherein the step of controlling the scene light according to the color set while the input image is displayed comprising:
accessing the scene file to retrieve a first color within the color subsets of the color set;
adjusting the scene light as the first color; and
changing the scene light to a second color within the color subsets of the color set according to the displaying sequence after the input image has been displayed for a predetermined period, wherein the predetermined period is a specific displaying duration of the displaying durations corresponding to the first color.

15. The method as claimed in claim 13, wherein before the step of controlling the scene light according to the color set while the input image is displayed, further comprising:
integrating the color set having a plurality of color subsets, the input image, other input images, and other color sets having a plurality of other color subsets corresponding to the other input images as a scene file, wherein the scene file comprises a displaying sequence of all of the color subsets and a plurality of displaying durations related to all of the color subsets;
wherein the step of controlling the scene light according to the color set while the input image is displayed comprising:
accessing the scene file to retrieve a first color within the all color subsets of the color set;
adjusting the scene light as the first color; and
changing the scene light to a second color within the all color subsets of the color set according to the displaying sequence after the input image has been displayed for a predetermined period, wherein the predetermined period is a specific displaying duration of the displaying durations corresponding to the first color.

16. The method as claimed in claim 1, further comprising:
retrieving a sound file; and
integrating the sound file, the color set, and the input image as a scene file.

17. The method as claimed in claim 16, wherein the step of integrating the sound file, the color set, and the input image as the scene file comprises:
dividing a playing duration of the sound file into a plurality of sections;
mapping a plurality of color subsets of the color set to at least one part of the sections;
integrating the mapped color subsets and the part of the sections with the input image as the scene file.

18. The method as claimed in claim 17, wherein the step of controlling the scene light according to the color set while the input image is displayed comprising:
accessing the scene file while the input image is displayed;
when a specific section of the part of the sections is displayed, adjusting the scene light as a specific color within the color subsets of the color set corresponding to the specific section.

19. An electronic apparatus, comprising:
a user interface unit;
a memory, storing information comprising program routines, the program routines comprising:
a retrieving module, retrieving an input image, wherein the input image comprises a plurality of pixels;
a classifying module, classifying the pixels into a plurality of categories according to color information of each of the pixels;
a selecting module, selecting a plurality of candidate colors according to the color information of each of the pixels; and
a generating module, generating a color set according to the categories and the candidate colors; and
a processing unit coupled to the user interface unit and the memory, executing the program routines.

20. The electronic apparatus as claimed in claim 19, wherein the selecting module selects the candidate colors from the categories according to the color information of each of the pixels.

21. The electronic apparatus as claimed in claim 19, wherein the classifying module classifies the pixels into the categories from the candidate colors according to the color information of each of the pixels.

22. The electronic apparatus as claimed in claim 19, wherein the classifying module performs a quantization process to the pixels to quantize the pixels into a plurality of specific data, wherein the specific data correspond to the categories.

23. The electronic apparatus as claimed in claim 19, wherein the classifying module performs a color quantization process to the pixels to quantize the pixels into a plurality of specific colors according to the color information having a color of each of the pixels, wherein the specific colors correspond to the categories.

24. The electronic apparatus as claimed in claim 19, wherein the classifying module performs a lightness quantization process to the pixels to quantize the pixels into a plurality of specific lightness according to the color information having a lightness of each of the pixels, wherein the specific lightness correspond to the categories.

25. The electronic apparatus as claimed in claim 19, wherein the classifying module performs a chroma quantization process to the pixels to quantize the pixels into a plurality of specific chromas according to the color information having a chroma of each of the pixels, wherein the specific chromas correspond to the categories.

26. The electronic apparatus as claimed in claim 19, wherein the classifying module performs a hue angle quantization process to the pixels to quantize the pixels into a plurality of specific hue angles according to the color information having a hue angle of each of the pixels, wherein the specific hue angles correspond to the categories.

27. The electronic apparatus as claimed in claim 19, wherein the selecting module:
chooses a plurality of specific pixels; and
sets colors of the chosen specific pixels as the candidate colors.

28. The electronic apparatus as claimed in claim 19, wherein the selecting module:
performs a quantization process to the pixels to quantize the pixels into a plurality of specific pixels;
generates a plurality of color histograms of the specific pixels;
selects a predetermined number of the specific pixels according to the color histograms; and
sets the selected specific pixels as the candidate colors.

29. The electronic apparatus as claimed in claim 28, wherein the selected predetermined number is determined by the specific pixels having predetermined color histograms.

30. The electronic apparatus as claimed in claim 19, wherein the generating module further controls a scene light of a light displaying device according to the color set.

31. The electronic apparatus as claimed in claim 19, wherein the generating module further controls a scene light of a light displaying device according to the color set while the input image is displayed, and the generating module further:
adjusts the scene light as a first color of the color set; and
changes the scene light to a second color of the color set after the input image has been displayed for a predetermined period.

32. The electronic apparatus as claimed in claim 31, wherein the generating module further integrates the color set having a plurality of color subsets, a displaying sequence of the color subsets, and a plurality of displaying durations related to the color subsets as a scene file, and the generating module further:
transmits the scene file to the light displaying device to control the light displaying device to further:
access the scene file to retrieve a first color within the color subsets of the color set;
adjust the scene light as the first color; and
change the scene light to a second color within the color subsets of the color set according to the displaying sequence after the input image has been displayed for a predetermined period, wherein the predetermined period is a specific displaying duration of the displaying durations corresponding to the first color.

33. The electronic apparatus as claimed in claim 31, wherein the generating module further integrates the color set having a plurality of color subsets, the input image, other input images, and other color sets having a plurality of other color subsets corresponding to the other input images as a scene file, wherein the scene file comprises a displaying sequence of all of the color subsets and a plurality of displaying durations related to all of the color subsets, and the generating module further:
transmits the scene file to the light displaying device to control the light displaying device to further:
access the scene file to retrieve a first color within the all color subsets of the color set;
adjust the scene light as the first color; and
change the scene light to a second color within the all color subsets of the color set according to the displaying sequence after the input image has been displayed for a predetermined period, wherein the predetermined period is a specific displaying duration of the displaying durations corresponding to the first color.

34. The electronic apparatus as claimed in claim 19, wherein the generating module further:
retrieves a sound file; and
integrates the sound file, the color set, and the input image as a scene file.

35. The electronic apparatus as claimed in claim 34, wherein the sound file has a playing duration, and the generating module further:
divides the playing duration into a plurality of sections;
maps a plurality of color subsets of the color set to at least one part of the sections;
integrates the mapped color subsets and the part of the sections with the input image as the scene file.

36. The electronic apparatus as claimed in claim 35, wherein the generating module further:
transmits the scene file to a light displaying device to control the light displaying device to further:
access the scene file while the input image is displayed;
when a specific section of the part of the sections is displayed by a sound playing device, adjust the scene light as a specific color within the color subsets of the color set corresponding to the specific section.

37. The electronic apparatus as claimed in claim 36, wherein the sound playing device is comprised in the electronic apparatus and is coupled to the processing unit.

38. The electronic apparatus as claimed in claim 30, wherein the light displaying device is comprised in the electronic apparatus and is coupled to the processing unit.
